(19) United States
(12) Patent Application Publication
(10) Pub. No.: US 2006/0176290 A1
(43) Pub. Date: Aug. 10, 2006

(54) Display device featuring a reduced amount of time for detecting video input signals

(75) Inventors: Subramanian Jayaram, Austin, TX (US); Samuel Nicklaus D'Alessio, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/053,774

(22) Filed: Feb. 9, 2005

(51) Int. Cl. G09G 5/00

(52) U.S. Cl. 345/204

(57) ABSTRACT

A display device includes a plurality of video input interfaces and a display controller. The display controller is operable for determining whether a specified video input interface included by the plurality of video input interfaces is coupled to a video source. This is accomplished while scanning the plurality of video input interfaces in a predetermined order for a video signal. The display controller is also operable for determining whether the specified video input interface is receiving a video signal from the video source. This is accomplished in response to determining that the specified video input interface is coupled to a video source.

### BACKGROUND

The description herein relates generally to information handling systems (“IHSs”) and more particularly to display devices that are coupled to IHSs.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A display device (e.g., a projector, liquid crystal display device, cathode ray tube (“CRT”) device, or a plasma display device) is capable of being coupled to an IHS to display information (e.g., video signals) received from such IHS. In one example, a display device is capable of receiving video signals from more than one source. Such display device includes multiple video input interfaces (e.g., digital video interface (“DVI”), M1 analog (“M1-a”) input interface, component video interface, and a video graphics array (“VGA”) interface),

A display device that includes multiple video input interfaces may cause various problems such as an increased amount of delay caused by the display device scanning for input signals.

What is needed is a method and a display device for detecting video signals in a reduced amount of time, without the disadvantages discussed above.

### SUMMARY

Accordingly, while scanning a plurality of video input interfaces in a predetermined order, a method provides for determining whether a specified video input interface included by the plurality of the video input interfaces is coupled to a video source. Also, in response to determining that the specified video input interface is coupled to a video source, the method provides for determining whether the specified video input interface is receiving a video signal from the video source.

### BRIEF DESCRIPTION OF THE DRAWINGS

FIG. 1 is a block diagram of an information handling system according to an illustrative embodiment.

FIG. 2 is a block diagram of a display device that is representative of the display device of FIG. 1.

FIG. 3 is a block diagram of a circuit for determining whether a video source is coupled to a video input interface, according to an embodiment.

FIG. 4 is a flow chart of operations performed by the display device of FIG. 2.

### DETAILED DESCRIPTION

For purposes of this disclosure, an information handling system (“IHS”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (“CPU”) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

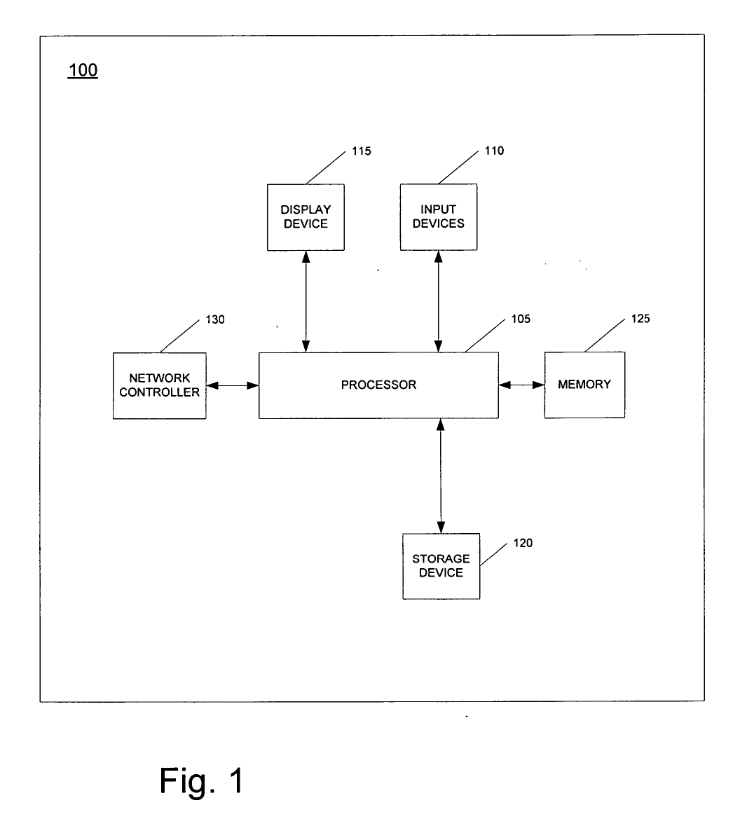

FIG. 1 is a block diagram of an IHS, indicated generally at 100, according to the illustrative embodiment. The IHS 100 includes a processor 105 (e.g., an Intel Pentium series processor) for executing and otherwise processing instructions, input devices 110 for receiving information from a human user, a display device 115 (e.g., a cathode ray tube (“CRT”) device, a projector, a liquid crystal display (“LCD”) device, or a plasma display device) for displaying information to the user, a storage device 120 (e.g., a non-volatile storage device such as a hard disk drive or other computer readable medium or apparatus) for storing information, a memory device 125 (e.g., random access memory (“RAM”) device and read only memory (“ROM”) device), also for storing information, and a network controller 130 for communicating between the IHS 100 and a network. Each of the input devices 110, the display device 115, the storage device 120, the memory device 125, and the network controller 130 is coupled to the processor 105, and to one another. In one example, the IHS 100 includes various other electronic circuitry for performing other operations of the IHS 100, such as a print device (e.g., a ink-jet printer or a laser printer) for printing visual images on paper.

The input devices 110 include, for example, a conventional keyboard and a pointing device (e.g., a “mouse”, a roller ball, or a light pen). A user operates the keyboard to input alphanumeric text information to the processor 105, and the processor receives such information from the keyboard. A user also operates the pointing device to input cursor-control information to the processor 105, and the processor 105 receives such cursor-control information from the pointing device.

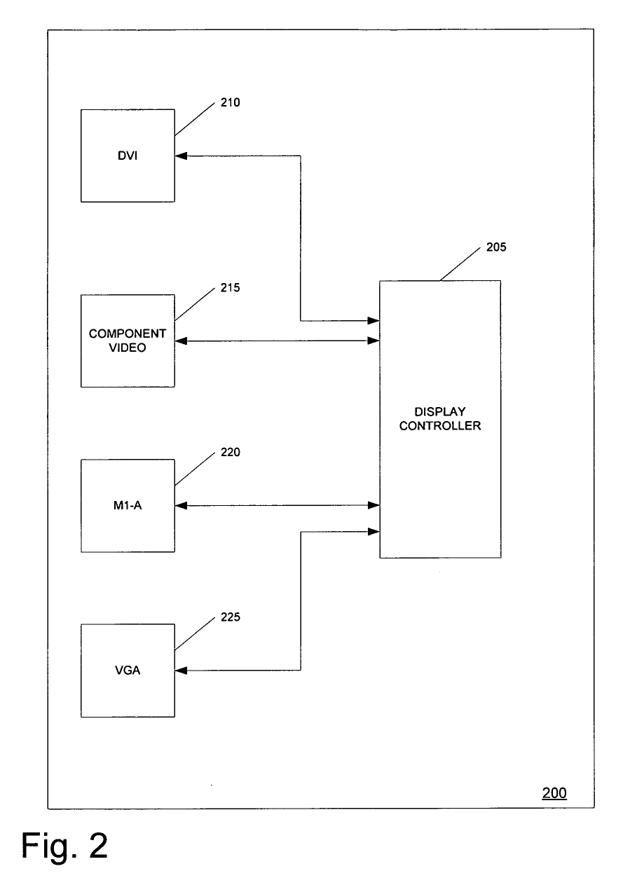

FIG. 2 is a block diagram of a display device, indicated generally at 200, that is representative of the display device 115 of FIG. 1. The display device 200 includes a display controller 205. The display device 200 also includes video input interfaces 210, 215, 220, and 225, each of which is coupled to the display controller 205. In the illustrative embodiment, each of the video input interfaces included by the display device 200, is of a different type from one another. For example, the input interfaces 210, 215, 220, and 225 are respectively, a digital video interface (“DVI”), a component video interface, M1-analog (“M1-a”) video interface, and a video graphics array (“VGA”) interface.

Via each of the interfaces 210, 215, 220, and 225, the display device 200 is capable of receiving video signals, and the display device 200 displays information (e.g., videos, images, and text) in response to such video signals. In one example, in response to the display device 200 powering on or resuming from a low power state (e.g., a suspend mode), the display controller 205, determines whether the display device 200 is receiving a video signal (e.g., through a video input interface included by the display device 200) by scanning the video input interfaces 210, 215, 220, and 225 in a predetermined order. However, if a video input source (e.g., the IHS 100) is coupled to a video input interface (e.g., the video interface 220 or 225) that is scanned later in the predetermined order, the display device 200 displays information in response to a video signal received form the video input source, after a delay associated with the scanning.

In another example, a user of an IHS (e.g., a portable IHS such as a laptop) may connect the IHS to the display device 200 as a secondary (e.g., external) display device. In such scenario, the user may enable the IHS' external video output after the display device 200 has scanned the video input interface to which the IHS is coupled. While the display device 200 is scanning its other video input interfaces, the display device 200 does not display information on its screen. During such delay, the user may incorrectly believe that the user did not initially enable the external video output, and attempt to enable the IHS' external video output again. For many IHSs, a single command switches between enabling and disabling an external video output. Accordingly, by attempting to enable the external video output a second time, the user may inadvertently disable the external video output. In such situation, the user may incorrectly believe that the IHS and/or the display device 200 is defective.

Accordingly, the display controller 205, while scanning the display device 200's video interfaces in the predetermined order, also determines whether a specified video input interface (e.g., the video interface 220 or 225) among the display device 200's video input interfaces is coupled to a video source. Moreover, in response to determining that the specified video input interface is coupled to a video source, the display controller 205 determines (e.g., by interrupting the scanning and sampling the specified video interface) whether the specified video input interface is receiving a video signal from the video source.

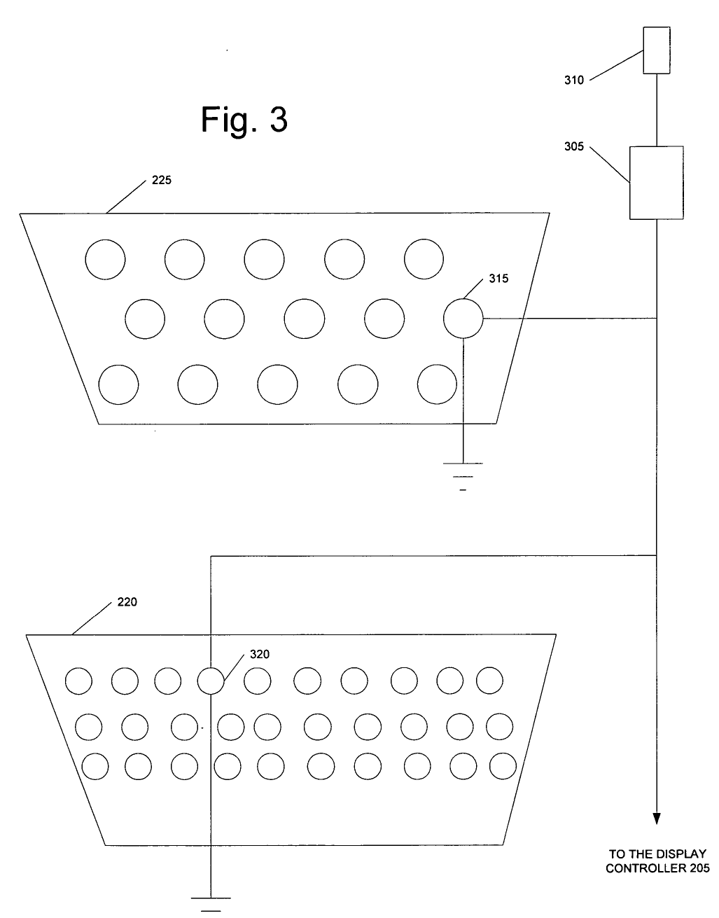

In an illustrative embodiment, the display controller 205 determines whether the specified video input interface is coupled to a video source in response to an interrupt signal. In one example, the display controller 205 determines that the specified video input interface is coupled to a video source, in response to determining that a cable (e.g., a video cable) is coupled to the specified video input interface. The display controller 205 determines whether a cable is coupled to the specified video input interface by determining whether a logic state of a pin included by the specified video interface has changed from a first state to a second state (discussed in more detail below in connection with FIG. 3).

Accordingly, FIG. 3 is a block diagram of a circuit for determining whether a video source is coupled to a video input interface. The circuit includes a resistor 305 and a voltage source (e.g., a power rail) that supplies voltage (e.g., 5 volts) to the resistor 305 and the circuit.

As shown, the resistor 305 is coupled to the display controller 205. The resistor 205 is also coupled to a grounded pin (e.g., pin 10) 315 of the VGA interface 225. In the illustrative embodiment, the resistor 305 is a “pull-up” resistor. Accordingly, the pin 315's initial state (e.g., a state while the video interface 225 is not coupled to a video cable) is set to “high” and the display controller 205 detects such state. However, in response to a video cable being coupled to the video input interface 225, the pin 315's logic state changes from its initial state of high to a low state. Thus, in response to determining that the pin 315's logic state is low, the display controller 205 also determines that the video input interface 225 is coupled to a video source. Moreover, the display controller 205 samples the video input interface 225 for a video signal.

In an alternative embodiment, the resistor 305 is a “pull-down” resistor. Accordingly, the pin 315's initial state while not coupled to a video cable is set to low, and the display controller 205 detects such state. In response to a video cable being coupled to the video input interface 225, the pin 315's logic state changes from its initial state of low to high. Accordingly, in response to determining that the pin 315's logic state is high, the display controller 205 also determines that the video input interface 225 is coupled to a video source via a video cable. Also, the display controller 205 samples the video input interface 225 for a video signal.

Referring again to FIG. 3, the resistor 305 and the display controller 205 are also coupled to a grounded pin 320 of the M1-a video interface 220. As shown, for the M1-a video interface 220, the grounded pin 320 is pin 4. The display controller 205 detects the pin 320's logic state in a manner substantially similar to the manner in which the display controller 205 detects pin 315's logic state as discussed above. Accordingly, the display controller 205 determines that a video source is coupled to the video input interface 220 in response to determining that the pin 315's state has changed from a first state (e.g., a initial state) to a second state. As discussed above, for the embodiment where the resistor 305 is a pull-up resistor, the first state is high and the second state is low. Conversely, for the embodiment where the resistor 305 is a pull-down resistor, the first state is low, and the second state is high.

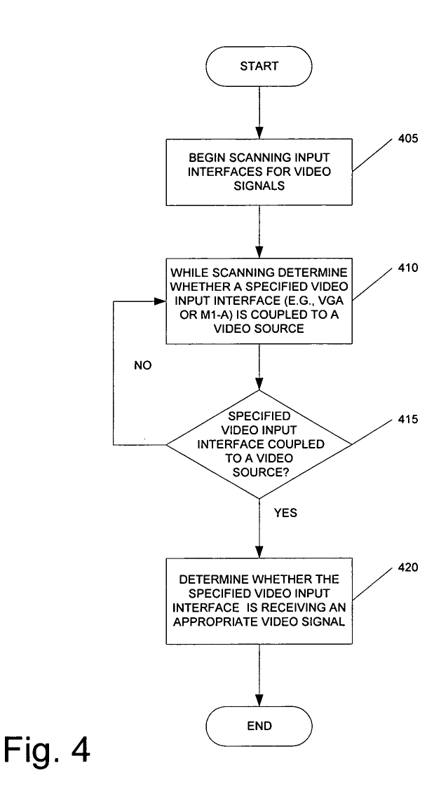

FIG. 4 is a flow chart of operations performed by the display device 200 of FIG. 2. In the illustrative embodiment, such operations are performed by the display controller 205 included by the display device 200. By performing the operations discussed below, the display device 200 detects video signals in a reduced amount of time.

The operation begins at a step 405, where the display device 200 begins scanning its video input interfaces for a video signal. After the step 405, the operation continues to a step 410.

At the step 410, the display device 200, while scanning the video input interfaces, also determines whether a video input interface (e.g., VGA or M1-a interface), that is specified, is coupled to a video source. In one example, as discussed above, the display device 200 makes such determination in response to an interrupt signal. After the step 410, the operation continues to a step 415.

At the step 415, if the display device 200 determines that the specified video input interface is coupled to a video source, the operation continues to a step 420. Otherwise, the operation returns to the step 410.

At the step 420, the display device 200 determines whether the specified video input interface coupled to the video source is receiving an appropriate video signal, by for example, sampling the specified video input interface. In response to determining that the specified video input interface is receiving an appropriate video signal, the display device 200 displays information on its screen.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method comprising:
while scanning a plurality of video input interfaces in a predetermined order, determining whether a specified video input interface, included by the plurality of the video input interfaces, is coupled to a video source; and
in response to determining that the specified video input interface is coupled to a video source, determining whether the specified video input interface is receiving a video signal from the video source.

2. The method of claim 1, wherein determining whether the specified video input interface is receiving a video signal from the video source includes sampling for an appropriate video signal.

3. The method of claim 1, wherein determining whether a specified video input interface is coupled to a video source includes determining whether a video cable is coupled to the specified video input interface.

4. The method of claim 3, wherein determining whether a video cable is coupled to the specified video input interface includes:
in response to an interrupt signal, determining that a video cable is coupled to the specified video input interface.

5. The method of claim 3, wherein determining whether a video cable is coupled to the specified video input interface includes:
in response to a logic state of a grounded pin of the specified video input interface changing from a first state to a second state, determining that a video cable is coupled to the specified video input interface.

6. The method of claim 5, wherein the first state is high and the second state is low.

7. The method of claim 5, wherein the first state is low and the second state is high.

8. The method of claim 5, wherein the specified video input interface is a video graphics array (“VGA”) interface, and the grounded pin is pin 10.

9. The method of claim 5, wherein the specified video input interface is a M1-analog (“M1-a”) video interface, and the grounded pin is pin 4.

10. A display device comprising:
a plurality of video input interfaces; and
a display controller for:
while scanning the plurality of video input interfaces in a predetermined order for a video signal, determining whether a specified video input interface included by the plurality of the video input interfaces is coupled to a video source; and
in response to determining that the specified video input interface is coupled to a video source, determining whether the specified video input interface is receiving a video signal from the video source.

11. The device of claim 10, wherein determining whether the specified video input interface is receiving a video signal from the video source includes sampling for an appropriate video signal.

12. The device of claim 10, wherein determining whether a specified video input interface is coupled to a video source includes determining whether a video cable is coupled to the specified one of the video input interface.

13. The device of claim 12, wherein determining whether a video cable is coupled to the specified video input interface includes:
in response to an interrupt signal, determining that a video cable is coupled to the specified video input interface.

14. The device of claim 12, wherein determining whether a video cable is coupled to the specified video input interface includes:
in response to a logic state of a grounded pin of the specified video input interface changing from a first state to a second state, determining that a video cable is coupled to the specified video input interface.

15. The device of claim 14, and comprising:
a resistor, coupled to the display controller, for setting the first state.

16. The device of claim 15, wherein the resistor is a pull-up resistor, the first state is high, and the second state is low.

17. The device of claim 15, wherein the resistor is a pull-down resistor, the first state is low, and the second state is high.

18. The device of claim 14, wherein the specified video input interface is a video graphics array (“VGA”) interface, and the grounded pin is pin 10.

19. The device of claim 14, wherein the specified video input interface is a M1-analog (“M1-a”) video interface, and the grounded pin is pin 4.

20. The device of claim 10, wherein the plurality of video input interfaces include a digital video interface (“DVI”).

21. The device of claim 10, wherein the plurality of video input interfaces include a component video interface.
